(19) United States
(12) Patent Application Publication
(10) Pub. No.: US 2013/0009890 A1
(43) Pub. Date: Jan. 10, 2013

(54) METHOD FOR OPERATING TOUCH NAVIGATION FUNCTION AND MOBILE TERMINAL SUPPORTING THE SAME

(75) Inventor: Soon Youl KWON, Suwon-si (KR)

(73) Assignee: SAMSUNG ELECTRONICS CO. LTD., Suwon-si (KR)

(21) Appl. No.: 13/525,612

(22) Filed: Jun. 18, 2012

(30) Foreign Application Priority Data
Jul. 7, 2011 (KR) 10-2011-0067314

(51) Int. Cl. G06F 3/041

(52) U.S. Cl. 345/173

(57) ABSTRACT

A method of operating a touch navigation function is provided. The method includes detecting a both hands gripping state of a mobile terminal, determining whether a virtual indicator for indicating a particular area of a display panel of the mobile terminal is called, determining whether at least one touch navigation key generating an event related to a control of a movement of the virtual indicator is called, displaying the at least one virtual indicator in the predetermined area of the display panel displaying the touch navigation key in at least one area of the display panel that is adjacent to an area in which both hands gripping the mobile terminal are located, and indicating the predetermined area of the display panel, moving the virtual indicator outputted on the predetermined area of the display panel, or activating the predetermined area of the display panel indicated by the virtual indicator.

### PRIORITY

This application claims the benefit under 35 U.S.C. §119(a) of a Korean patent application filed on Jul. 7, 2011 in the Korean Intellectual Property Office and assigned Serial No. 10-2011-0067314, the entire disclosure of which is hereby incorporated by reference.

### BACKGROUND OF THE INVENTION

1. Field of the Invention

The present invention relates to a mobile terminal. More particularly, the present invention relates to a method of operating a touch navigation function to allow a user to select a particular position on a screen or activate an icon with ease while gripping a mobile terminal with both hands and the mobile terminal supporting the same.

2. Description of the Related Art

A mobile terminal supports a call function that allows for mobility of the mobile terminal, and thus, the mobile terminal is used in a wide range of areas and situations due to ease of use and portability. The mobile terminal provides various input methods to provide a user function. For example, a conventional mobile terminal provides a touch screen that includes a touch panel and a display unit so that the touch panel may process a user's input operation that is performed to select a particular image viewable on the display unit. Also, the mobile terminal generates a touch event according to a corresponding user operation and controls an application program that corresponds to the user function based on the generated touch event. Furthermore, the mobile terminal supports various functions, such as a multimedia application, an electronic book (e-book), Internet browsing, a game, and other similar functions that are executable on portable electronic devices. Accordingly, a mobile terminal equipped with a large touch screen has emerged in order to provide a more enjoyable multimedia experience and enhanced convenience of use of various application programs.

Meanwhile, due to a an increased size of the touch screen, the mobile terminal has an increased weight, and thus, when a user wants to touch a particular icon in a Graphical User Interface (GUI) of a large screen mobile terminal, it is difficult for the user to perform a touch operation for a longer period of time while gripping the mobile device with one hand. Due to this difficulty, the user typically grips a mobile phone with both hands. However, when the user grips the mobile terminal with both hands, the touch operation has a limited range of usable areas close to where the mobile terminal is gripped, e.g., an edge area of the touch screen. Thus, a great inconvenience is caused when selecting a particular icon located on a predetermined area or selecting a particular area of the screen.

In addition, in a mobile terminal of the related-art, the touch operation is required to have a wide range regardless of a gripping state of the mobile terminal due to the increased size of the touch screen. Particularly, when an icon which the user desires to select is located far away from a hand that grips the mobile terminal, the mobile terminal cannot be gripped by both hands when selecting the particular icon. Thus, the user needs to support the mobile terminal with one hand and perform the touch operation with the other hand in order to select the particular icon, which is inconvenient and risky in that the mobile terminal may be dropped.

### SUMMARY OF THE INVENTION

Aspects of the present invention are to address at least the above-mentioned problems and/or disadvantages and to provide at least the advantages described below. Accordingly, an aspect of the present invention is to provide a method of operating a touch navigation function to allow selecting a particular position on a screen or activating an icon through a touch operation within a limited area and a mobile terminal supporting the same.

According to an aspect of the present invention, a method of operating a touch navigation function is provided. The method includes detecting a both hands gripping state of a mobile terminal if both hands of a user are gripping the mobile terminal, determining whether a virtual indicator for indicating a particular area of a display panel of the mobile terminal is called, determining whether at least one touch navigation key configured to generate an event related to a control of a movement of the virtual indicator is called, displaying the at least one virtual indicator in the predetermined area of the display panel if it is determined that the virtual indicator is called, displaying the touch navigation key in at least one area of the display panel that is adjacent to an area in which both hands gripping the mobile terminal are located if it is determined that the at least one navigation key is called, and performing, based on a predefined touch event generated according to a control of the touch navigation key, at least one of, a function to indicate the predetermined area of the display panel, a function to move the virtual indicator outputted on the predetermined area of the display panel, and a function to activate the predetermined area of the display panel indicated by the virtual indicator.

According to another aspect of the present invention, a mobile terminal supporting a touch navigation function is provided. The mobile terminal includes a display panel for displaying a virtual indicator for indicating a particular area and at least one touch navigation key for generating an event related to movement of the virtual indicator and for controlling the movement of the virtual indicator, a touch panel for generating a touch event according to a user input and for generating a predefined touch event according to a both hands gripping state, and a controller for controlling a displaying of the touch navigation key in an area of the display panel that is adjacent to an area in which both hands of a user gripping the mobile terminal are located when the both hands gripping state is detected.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram illustrating an internal configuration of a mobile terminal according to an exemplary embodiment of the present invention;

FIG. 2 is a block diagram illustrating a configuration of a controller of FIG. 1 according to an exemplary embodiment of the present invention;

FIG. 3 is a flowchart diagram illustrating a process of operating a touch navigation function according an exemplary embodiment of the present invention;

FIGS. 4A and 4B illustrate a mobile terminal gripped by both hands of a user according to an exemplary embodiment of the present invention; and

FIGS. 5A through 5D are example screens displayed when a touch navigation key and a virtual indicator are outputted according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Hereinafter, exemplary embodiments of the present invention will be described with reference to the accompanying drawings. In the following description, the term “touch navigation function” is defined as a function to support at least one of a function to indicate a certain area on a display panel, a function to indicate a certain area selectable through a soft-key input such as, for example, an icon on a standby screen or an icon for performing a predetermined function in a Graphical User Interface (GUI) of a specific application program, a function to move an indication of the certain selectable area in a predetermined direction, and a function to activate a function associated with a selected certain area when the certain area that is indicated as being selectable is selected. Here, the function associated with the selected certain area is a function to change a characteristic of the selected certain area such as a color or a mapping function thereof according to a particular application program, or, if the selected certain area corresponds to an icon, a function associated with the icon. Namely, the touch navigation function supports at least one of a function to indicate or select a certain area of a screen, e.g., a particular icon, and a function to activate the certain area.

In the exemplary embodiments of the present invention, the mobile terminal displays a touch navigation key on at least one location that is adjacent to an area at which the mobile terminal is gripped by both hands of a user, according to the user's request. In addition, in the exemplary embodiments of the present invention, a virtual indicator for indicating a particular area or icon is displayed when the touch navigation key is displayed. As such, the exemplary embodiments of the present invention support an operation of the touch navigation function based on a control of the touch navigation key and the virtual indicator. Thus, the exemplary embodiments of the present invention have advantages in that a particular area on the touch screen or an area in which a particular icon is located can be easily touched and selected by a touch operation of a limited range.

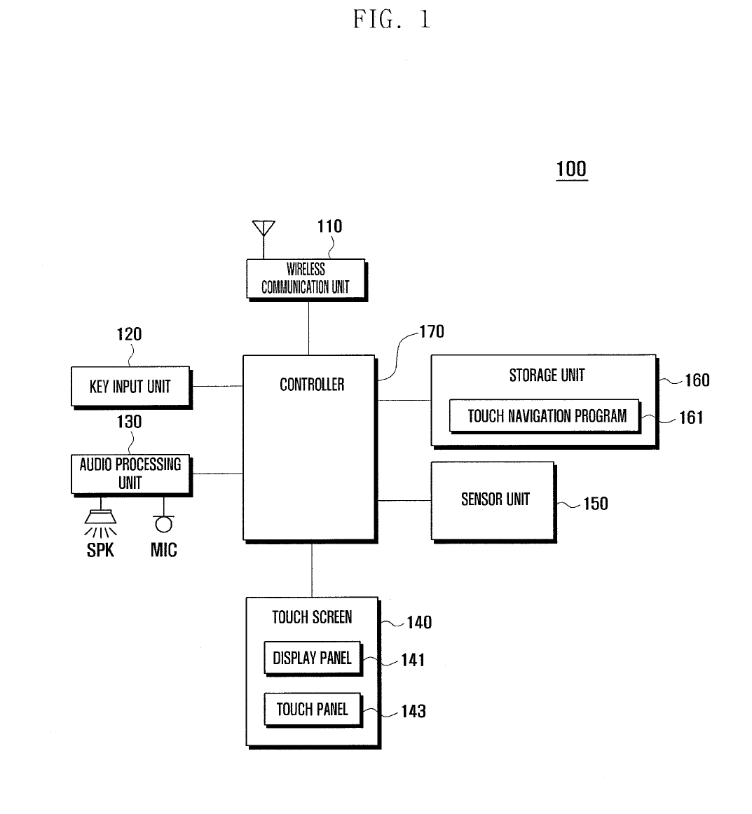

Meanwhile, it is assumed that the touch navigation function is operated after a setting mode for operating the touch navigation function has been entered. However, the present invention is not limited thereto, and the touch navigation function may be provided as a default function that may be operated without entering a separate setting mode. Here, the setting mode is entered according to a user's request. In this case, parameters for operating the setting mode may include, for example, a gripping detection area, a both hands gripping state notification touch event, a call area, a call touch event, various types of the touch navigation key, a moving range of the virtual indicator, various types of the virtual indicator, and initial output position information of the touch navigation key and the virtual indicator, and other similar parameters. A both hands gripping state detection unit may be provided and the both hands gripping state detection unit may include at least one of a touch panel 143 (see FIG. 1) and a sensor unit 150 (see FIG. 1). The both hands gripping state detection unit detects a both hands gripping state based on a signal obtained by at least one of the touch panel 143 and the sensor unit 150 depending, wherein the signal is based on a user setting or a terminal setting.

Here, the gripping detection area is a predetermined area of a screen, for example, an edge area of a display panel 141 (see FIG. 1) having a predetermined width in which icons are not displayed, and the predetermined area of the screen is defined in a manner so as to allow a determination on whether the user grips a mobile terminal 100 (see FIG. 1) with both hands to use the mobile terminal 100, i.e., detecting a both hands gripping state of the mobile terminal 100. Also, the call area is an area for detecting a call for the touch navigation key and the virtual indicator, and when a particular event occurs in a certain call area, a call touch event corresponding to the certain call area may be generated. The gripping detection area and the call area may be areas defined in advance by a predetermined area of the touch panel 143, for example, an area having a predetermined width on at least one side surface of the touch panel 143. In the setting mode, locations and widths of the gripping detection area and the call area may respectively be adjusted according to the user setting or a design intent of a mobile terminal designer. The locations of these areas may be manually set or automatically set. In a case of a manual setting, the location of the gripping detection area and the call area may be set as one of four side surfaces or at least two side surfaces of the four side surfaces of the touch panel 143 according to a user input. Here, the user may select a side surface of the mobile terminal that is frequently gripped as the gripping detection area and the call area. In case of an automatic setting, the locations of the gripping detection area and the call area may be set to be determined according to a view mode of the mobile terminal 100, i.e., a vertical view mode (also known as portrait view mode) or a horizontal view mode (also known as a landscape view mode).

For example, when the mobile terminal 100 is in the horizontal view mode, the gripping detection area and the call area may be automatically set as being located at a side surface of the touch panel that is perpendicular to the horizontal view mode. The view mode of the mobile terminal 100 may be determined according to a particular application program being executed by the mobile terminal 100 or a posture of the mobile terminal 100. Thus, the locations of the gripping detection area and the call area may be changed according to which view mode is used for the particular application program or the posture of the mobile terminal 100. The gripping detection area and the call area described above may be an identical area, or in other words, may be in a same area of the mobile terminal 100. For example, when the mobile terminal 100 is set to output the touch navigation key and the virtual indicator upon detection of the both hands gripping state, the griping detection area and the call area may be defined as one area instead of separate areas. Meanwhile, when it is set to perform the both hands gripping state detection independently of the output of the touch navigation key and the virtual indicator according to the both hands gripping state detection, the griping detection area and the call area can be defined as separate or

For example, the mobile terminal, according to the present exemplary embodiments of the present invention, may be set to switch from a certain mode to the touch navigation function mode according to the both hands gripping detection, and may set to output the touch navigation key and the virtual indicator according to the call event generated in the call area. In such a case, even when the gripping detection area and the call area are defined as the same area, each area may be defined as an area that performs different functions. In other words, in such a case, the gripping detection area and the call area are defined as the same area but have respective and different functions in the same area. Meanwhile, a size of the gripping detection area and a size of the call area may be different from each other when implemented in different areas according to the user setting or intent of the mobile terminal designer.

The both hands gripping state notification touch event may be a touch event that is generated at two side surfaces of the gripping detection area. Here, the both hands gripping state notification touch event may be generated by touch operations that occur within a predetermined time period or that occur almost simultaneously at the two side surfaces of the gripping detection area. The both hands gripping state notification touch event may be set as an event generated by various types of touch operations, such as a long touch or a predetermined number of taps within the gripping detection area.

The touch navigation key may be implemented as a combination of an arrow key and a select key, a key or icon displayed on a touch pad, or a variety of images having at least two moving directions for the virtual indicator such that an icon indicated by the virtual indicator may be selected and activated. Also, the virtual indicator may be implemented as a pointer, an icon boundary highlighter for highlighting an icon, or any image for indicating an icon to be selected to perform a corresponding function.

Hereinafter, an exemplary method of operating a touch navigation function and a mobile terminal for supporting the same will be described.

FIG. 1 is a block diagram illustrating an internal configuration of a mobile terminal according to an exemplary embodiment of the present invention. Here, it is assumed that the mobile terminal is a tablet computer or a portable phone.

Referring to FIG. 1, the mobile terminal 100 includes a wireless communication unit 110, a key input unit 120, an audio processing unit 130, a touch screen 140, a storage unit 160, and a controller 170. Also, the mobile terminal 100 may selectively include a sensor unit 150.

The mobile terminal 100 may indicate, select, and activate icons positioned in various areas by providing a touch navigation key and a virtual indicator on the touch screen 140 when it is detected that the mobile terminal 100 is being gripped by both hands of the user.

The wireless communication unit 110, under the control of the controller 170, provides communication channels for a voice call, a video call, and transmission of data, such as an image or a message. In other words, the wireless communication unit 110 provides a voice call channel, a data communication channel, and a video call channel between mobile communication systems. A user function utilizing the wireless communication unit 110 may be selected and activated through a touch event occurring on a particular icon or keymap displayed on the mobile device 100.

In this process of selecting and activating the user function, the mobile device 100 may provide the touch navigation key and the virtual indicator for selecting and activating the particular icon or keymap. Here, the mobile device 100 displays the touch navigation key and the virtual indicator on at least one specific point of the touch screen 140, and particularly on an area adjacent to user's hands that grip the mobile terminal 100. Accordingly, the user can select a particular icon or a particular key of the keymap by one or both hands so as to use a function of the wireless communication unit 110 by using the touch navigation key and the virtual indicator while gripping the mobile terminal 100. In other words, the user may use a function of the voice call, the video call and the data transmission of the wireless communication unit 110 based on an operation of the touch navigation key and the virtual indicator regardless of a screen size of the mobile terminal 100 or the gripping state thereof.

The key input unit 120 includes a plurality of input keys and function keys to receive number or character information and to set various functions. The function keys may include an arrow key, a side key, a shortcut key set for performing a particular function, and a variety of other similar keys for performing functions. Also, the key input unit 120 generates a key signal related to the user setting and function control of the mobile terminal 100 and transmits the key signal to the controller 170. In a case where the touch screen 140 is provided as a full touch screen, the key input unit 120 may include only the side key positioned on a side surface of a case of the mobile terminal 100. Particularly, the key input unit 120 may be implemented by the touch navigation key and the virtual indicator outputted on the display panel 141. However, the present invention is not limited thereto and the key input unit 120 may be implemented in a variety of suitable manners. The touch navigation key moves the virtual indicator according to a user's touch operation to select an icon and so as to allow execution of a function associated with the selected icon. The touch navigation key and the virtual indicator are described in detail below.

An audio processing unit 130 includes a speaker (SPK) for reproducing audio data that is transmitted and received during a call, audio data contained in a received message, audio data of an audio file stored in a storage unit 160, or any other similar audio data, and a microphone (MIC) for collecting a user's voice and other audio signals during the call or at other times of operating the mobile device 100. The audio processing unit 130 may output a corresponding sound effect when the touch navigation key and the virtual indicator are outputted on the display panel 141. Also, the audio processing unit 130 may output a corresponding sound effect when particular input signals are received according to an interactive operation of the touch navigation key and the virtual indicator or other interactive operations of the mobile device 100. Particularly, the audio processing unit 130 may output a sound effect when an icon indicated by the virtual indicator is changed so as to notify a modification of a selectable icon. Such sound effects, related to a touch navigation operation, may be omitted depending on the user settings.

The touch screen 140 includes the display panel 141 and the touch panel 143. The touch screen 140 may have a structure in which the touch panel 143 is positioned on top of the display panel 141. A size of the touch screen 140 may be determined by a size of the touch panel 143.

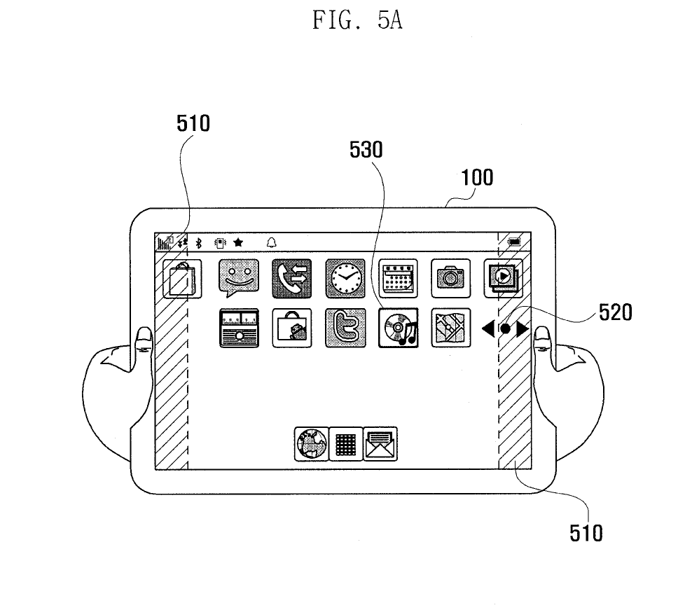

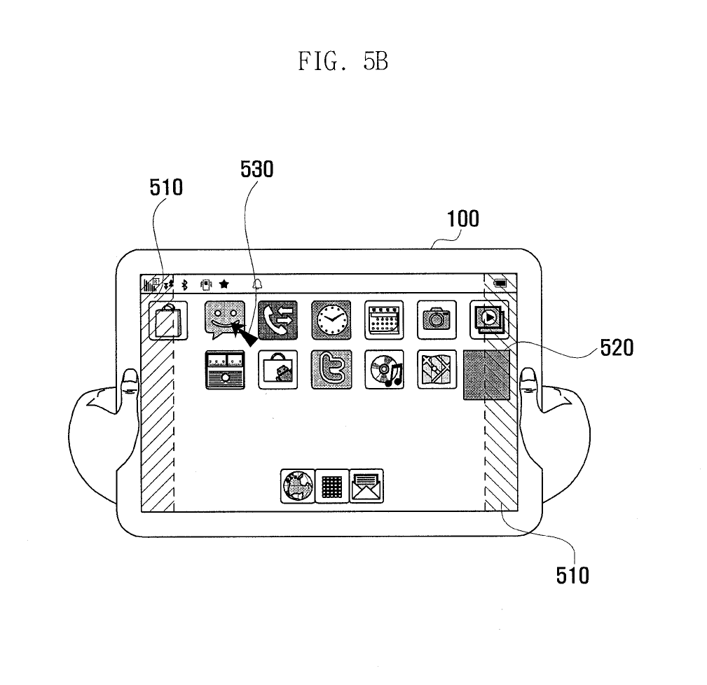

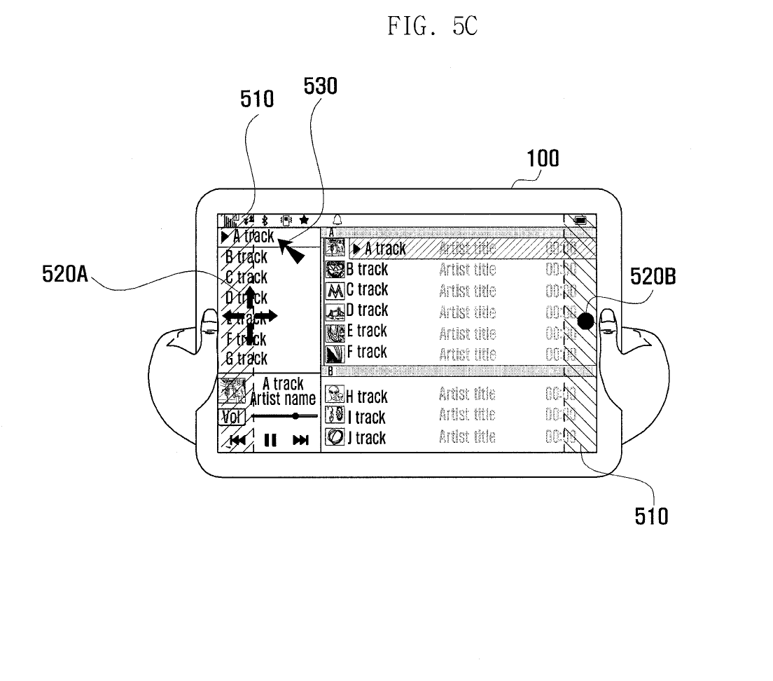

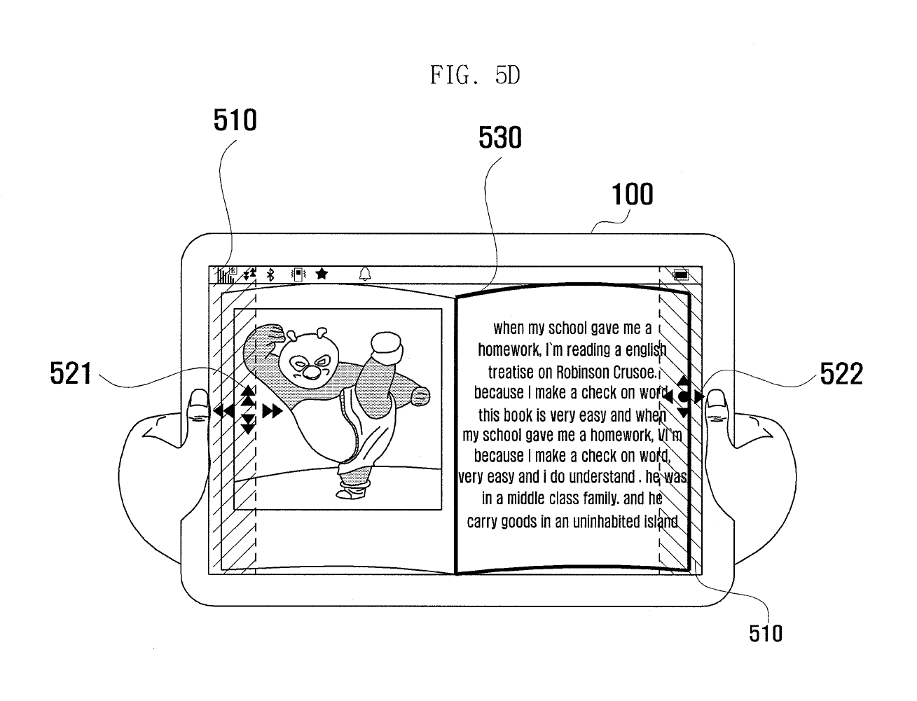

The display panel 141 displays various menus of the mobile terminal 100 as well as information entered by the user or information provided to the user. Namely, the display panel 141 may display various screens according to a use of the mobile terminal 100, such as a standby screen, a menu screen, an e-book screen, an application screen, and other similar screens. The display panel 141 may be formed in a Liquid Crystal Display (LCD) or an Organic Light Emitted Diode (OLED). Also, the display panel 141 may be positioned above or below the touch panel 143. Particularly, when the mobile terminal 100 is gripped by both hands of a user, the display panel 141 may output a screen associated with various user functions and, at the same time, output the touch navigation key on at least one position adjacent to an area at which the mobile terminal 100 is gripped. Also, the display panel 141 may output the virtual indicator at a particular position and provide a display effect such as moving the virtual indicator according to the operation of the touch navigation key or indicating a particular icon. A screen output according to an operation of the user function of the mobile terminal 100 based on the touch navigation key and the virtual indicator will be described in detail below with reference to FIGS. 5A through 5D.

The touch panel 143 may be positioned on at least one of an upper portion and a lower portion of the display panel 141 and generate a touch event according to a contact by an object or a distance approached by the object, wherein the touch event is to be transmitted to the controller 170. Here, a sensor (not shown) that constitutes the touch panel 143 may be arranged in a matrix form and may transmit information of a position on the touch panel 143 corresponding to the touch event and information about a type of the touch event, with respect to a single-touch or a multi-touch occurring on the touch panel 143. Touch events for operating the touch navigation function may include a touch event in the gripping area, which is predefined for detecting the both hands gripping state, a call touch event in the call area when the gripping state is detected, and a touch event for performing the touch navigation function in an area in which the touch navigation key is outputted (hereinafter, referred to as “navigation performing touch event”). The above described touch events may be one of a touch down event in which the touch panel is touched by the object, a drop event in which the contact by the object is released, a long touch event in which the touch down condition is maintained for a predetermined time period prior to a touch release or the drop event, and a tap event for executing a function corresponding to a tap on the touch panel.

The sensor unit 150 is configured to collect sensing information by using at least one proximity sensor (not shown). The proximity sensor may be implemented in various forms, such as a magnetic type, a magnetic saturation type, a high frequency oscillation type, a differential coil type, a capacitance type, a laser transceiver type, and other similar sensor types. Also, each proximity sensor generates the sensing information corresponding to a particular object that approaches the proximity sensor and transmits the sensing information to the controller. Particularly, the sensor unit 150 is positioned at an edge area of a rear surface of the mobile terminal 100. Accordingly, when the user approaches a certain area of the rear surface of the mobile terminal 100, that is, the sensor unit 150, via a hand or other object, at least one proximity sensor included in the sensor unit 150 may generate the sensing information of the user's approach. Also, the sensor unit 150 may transmit the sensing information to the controller 170.

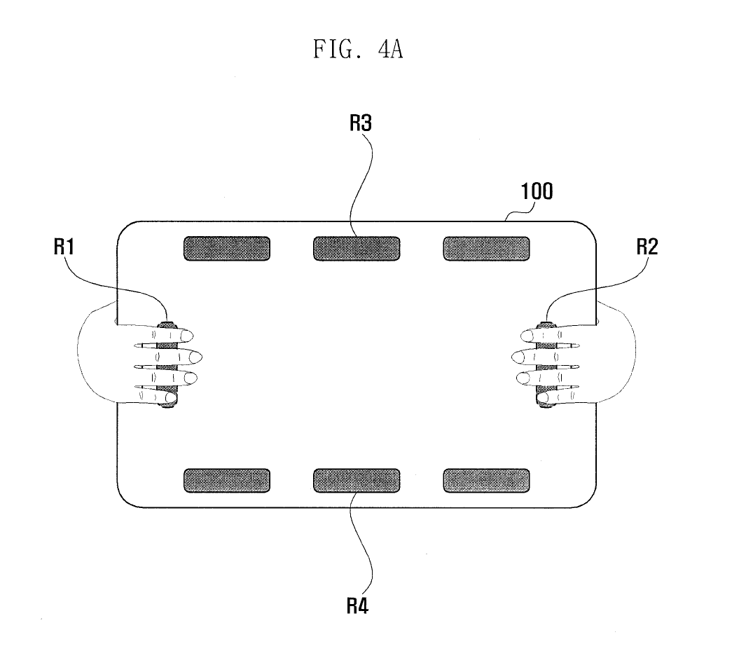

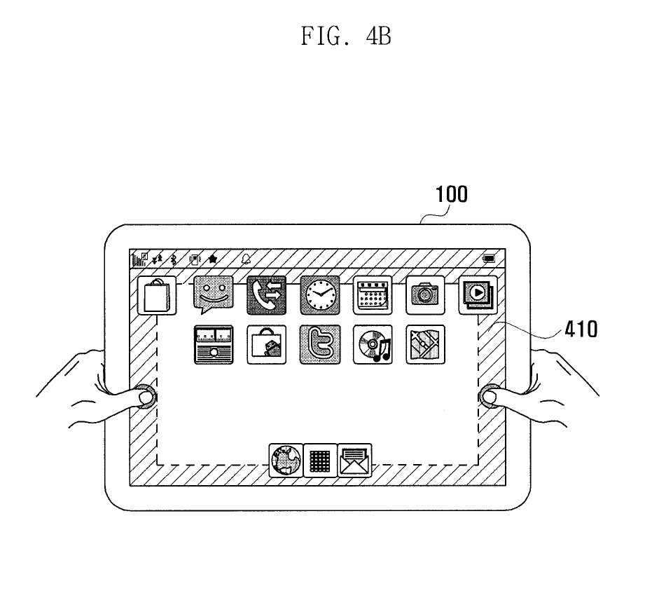

Particularly, the sensor unit 150 may include proximity sensors disposed on at least two side surfaces of the rear surface of the mobile terminal 100. However, the present invention is not limited thereto, and the proximity sensor may be disposed in any suitable manner. Also, by disposing at least one proximity sensor on each side surface of the mobile terminal 100, a user's approach may be precisely detected. Preferably, a plurality of the proximity sensors may be positioned on each side surface of the rear surface of the mobile terminal 100. It is preferable that the proximity sensors are arranged in an array structure. An operation of the sensor unit 150 will be described in detail below with reference to FIG. 4A.

The storage unit 160 may include a key map or an icon map for operating the touch screen 140 as well as an application program required to operate a function according to an exemplary embodiment of the present invention. Here, the key map or the icon map may be various suitable types of key maps and icon maps. Namely, the keymap may be a keyboard keymap, a 3*4 key map, or a QWERTY key map, or a control key map for controlling an operation of an application program being currently executed. Also, the icon map may be an icon map for controlling the operation of the application program being currently executed. The storage unit 160 may include a data area and a program area, or a variety of other similar areas for storing information.

In the program area, an Operating System (OS) for booting the mobile terminal 100 and operating the above described elements and operations, an application program for reproducing various files, such as an application program for supporting a call function of the mobile terminal 100, a web browser for connecting to an internet server, an MP3 application program for reproducing various sound sources, an image outputting application program for reproducing pictures, a video reproducing application program, an E-book application program, and a variety of other similar program application. Particularly, a touch navigation program 161 may be stored in the program area of the present invention.

The touch navigation program 161 supports an output of the touch navigation key that is outputted in the both hands gripping state of the mobile terminal 100 and supports an execution of a particular function mapped to an icon positioned at various locations. In order to support such, the touch navigation program 161 generates an event related to the control of the virtual indicator through the operation of the touch navigation key, such as moving the virtual indicator or indicating or selecting the particular icon to be activated. To this end, the touch navigation program 161 includes a routine for determining whether the mobile terminal 100 is in the both hands gripping state, a routine for determining whether the touch navigation key and the virtual indicator are called when it is determined that the mobile terminal 100 is in the both hands gripping state, a routine for outputting the touch navigation key and the virtual indicator when the touch navigation key and virtual indicator are called, and a routine for performing the touch navigation function according to the touch navigation key. Furthermore, the touch navigation program 161 may include a routine for removing the touch navigation key and the virtual indicator from the display panel 141.

The data area is an area for storing data generated according to the use of the mobile terminal 100. In the data area, at least one icon for performing supported application programs and an e-book application, or various contents used in the application program or the e-book application may be stored. Also, the data area may store user input entered through the touch panel 143. Particularly, the data area may store information used or generated when the touch navigation program is being executed.

Specifically, the data area stores a signal for executing the touch navigation function, position information of the touch navigation key on the display panel 141, and position information of the virtual indicator. Also, the data area further stores setting information that is set in advance in order to perform the touch navigation function. That is, the data area stores information corresponding to the gripping detection area set in advance according to a user's preference, the both hands gripping state notification touch event, the call area, the call touch event, various types of the touch navigation key, various types of the virtual indicator, and initial output position information of the touch navigation key and the virtual indicator. Such information may be referred to by the touch navigation program 161 in a manner related to the output and utilization of the touch navigation key and the virtual indicator and their use.

The controller 170 controls a power supply to each element of the mobile terminal 100 in order to perform an initialization process. First, the controller 170 of the present invention determines whether the mobile terminal 100 is being gripped by both hands of the user based on information received from the touch panel 143 or the sensor unit 150. When the both hands gripping state is detected, the controller 170 determines whether the touch navigation key and the virtual indicator are called based on information received from the touch panel 143 under the both hands griping state. When it is determined that touch navigation key and the virtual indicator are called, the controller 170 controls displaying of the touch navigation key and the virtual indicator on the display panel 141. Here, the controller 170 controls the displaying such that, as the touch navigation key is displayed at at least one position adjacent to the area at which the mobile terminal 100 is gripped by both hands. Next, the controller 170 supports the touch navigation function according to an input signal generated through the touch navigation key.

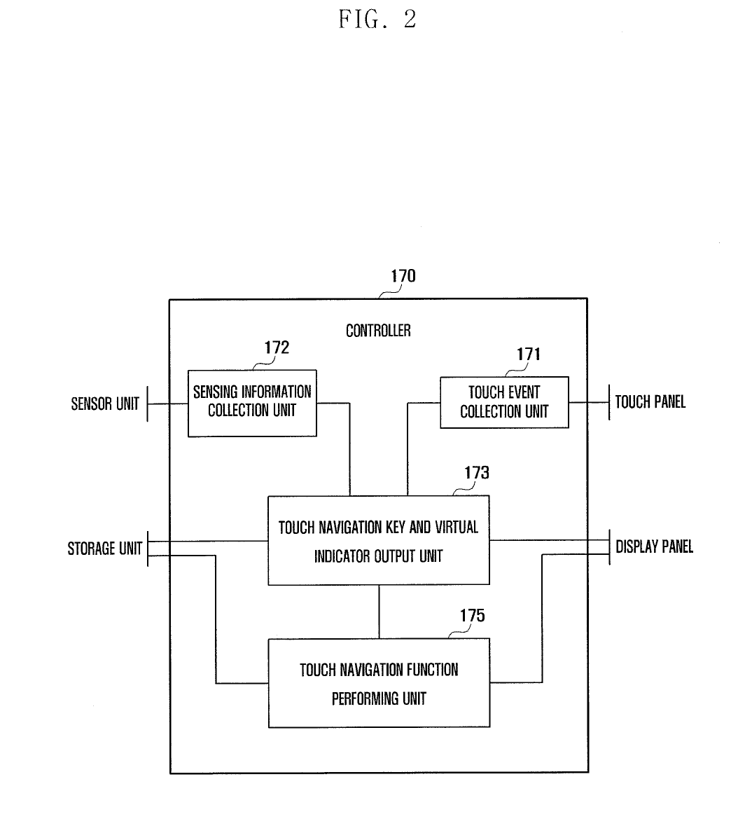

FIG. 2 is a block diagram illustrating a configuration of a controller of FIG. 1 according to an exemplary embodiment of the present invention

Referring to FIG. 2, the controller 170 may include a touch event collection unit 171, a touch navigation key and virtual indicator output unit 173, and a touch navigation function performing unit 175. Meanwhile, the controller 170 may further include a sensing information collection unit 172 in a case where the sensor unit 150 is set to determine the both hands gripping state. Hereinafter, elements of the controller 170, according to an exemplary embodiment in which the touch panel 143 is used to determine the both hands gripping state, are first discussed. Elements of the controller 170, according to an exemplary embodiment in which the sensor unit 150 is used to determine the both hands gripping state, will be later discussed.

The touch event collection unit 171 is configured to collect information related to the touch event occurring on the touch panel 143. Particularly, when the touch event collection unit 171 is set to determine the both hands gripping state based on the touch event occurring on the touch panel 143, it may determine whether the both hands gripping state notification touch event is generated according to a corresponding touch operation when the corresponding touch operation occurs within the gripping detection area. The received touch event is compared with the both hands gripping state notification touch event that is defined in advance. Based on comparison, when it is determined that the touch event received from the touch panel 143 is not the both hands gripping state notification touch event, the touch collection unit 171 may control performing of a function of the mobile terminal 100 according to the corresponding touch event.

On the other hand, when the collected touch event information is the both hands gripping state notification touch event, the touch event collection unit 171 may determine that the mobile terminal 100 is in the both hands gripping state.

Also, when it is determined that the mobile terminal 100 is in the both hands gripping state, the touch collection unit 171 determines whether the call touch event is generated in the call area, from among the touch events generated in the call area. When the collected touch event is not the call touch event in the call area, the touch collection unit 171 may control performing of the function of the mobile terminal 100 according to the corresponding touch event. On the other hand, when the collected touch event is the call touch event in the call area, the touch event collection unit 171 may transfer the call touch event, the both hands gripping state notification touch event, and the position information thereof to the touch navigation key and virtual indicator output unit 173.

Next, the touch collection unit 171 may collect information corresponding to the navigation performing touch event occurring in an area in which the touch navigation key is outputted and transmit the navigation performing event information and the position information of the navigation performing event to the touch navigation function performing unit 175. The navigation performing touch event may include a touch navigation key moving event for moving a position of the touch navigation key according to user preference, a virtual indicator moving event associated with the control of the virtual indicator, and a touch event for selecting a particular area, such as an icon, indicated by the virtual indicator.

When it is determined that the mobile terminal 100 is in the both hands gripping state, the touch navigation key and virtual indicator output unit 173 control a displaying of the touch navigation key and the virtual indicator such that they are overlaid and outputted to the display panel 141. Here, when the call touch event is generated or the both hands gripping state is detected, the touch navigation key and virtual indicator output unit 173 control the displaying of the touch navigation key and the virtual indicator according to the user setting such that they are outputted to the display panel 141. When the call touch event is generated, the touch navigation key and virtual indicator output unit 173 controls displaying of the touch navigation key on the display panel 141 at a location in which the call touch event is generated based on the received call touch event and the position information thereof.

Accordingly, in an exemplary embodiment of the present invention, the touch navigation key may be displayed within a range of expected movement of a user's finger or an object that is used to perform the touch operation while the mobile terminal 100 is being gripped. Meanwhile, when the both hands gripping state is detected, the touch navigation key and virtual indicator output unit 173 may immediately detect whether it is set to display the touch navigation key and the virtual indicator, i.e., whether an automatic call is set up. Here, the touch navigation key and virtual indicator output unit 173 may identify particular information so as to determine the both hands gripping state. Here, the particular information may be the both hands gripping state touch event notification information and the position information thereof from the touch event collection unit 171 or the sensing information received from the sensor unit 150, depending on the elements of the mobile terminal 100 used for detecting the both hands gripping state.

When the mobile terminal 100 uses the touch panel 143 to detect the both hands gripping state, the touch navigation key and virtual indicator output unit 173 controls displaying of the touch navigation key at at least one position of the display panel 141 in which the both hand notification touch event is generated according to the position information thereof. Accordingly, the touch navigation key may be displayed at a particular area of the display panel 141 that is adjacent to an area in which the mobile terminal 100 is gripped.

Meanwhile, when the automatic call is set up and it is determined that the mobile terminal 100 is gripped by both hands of the user, the touch navigation key and virtual indicator output unit 173 may control displaying of the touch navigation key on the display panel 141 based on the initial output position information that is predetermined. Here, the predetermined initial output position information of the touch navigation key may generally be an area adjacent to an area at which the mobile terminal 100 is gripped by the user. For example, the area may be a left or right side of a center area, an upper or lower portion of the center area, or any other suitable area of the display panel 141. Accordingly, the touch navigation key and virtual indicator output unit 173 may control displaying of the touch navigation key on the display panel 141 to be at an area of the display panel 141 that is closest to the area at which the mobile terminal 100 is gripped.

In addition, the touch navigation key and virtual indicator output unit 173 may control displaying of the virtual indicator to be at a position indicating a particular icon on the display panel 141 based on predetermined initial output information of the virtual indicator. Preferably, the touch navigation key and virtual indicator output unit 173 may display the virtual indicator so as to indicate an icon that is located farther away from the area at which the mobile terminal 100 is gripped or from the area in which the touch navigation key is displayed. For example, the virtual indicator may be displayed so as to indicate an icon located close to the center area of the display panel 141 or located at an edge area of the display panel 141.

The touch navigation function performing unit 175 moves the touch navigation key and the virtual indicator according to the user's input received via the touch navigation key and performs a corresponding function of a predetermined area indicated by the virtual indicator, e.g., the function corresponding to a particular icon located at the predetermined area. The touch navigation function performing unit 175 refers to the position of the touch navigation key and the virtual indicator by accessing the storage unit 160. Also, the touch navigation function performing unit 175 determines whether the navigation performing touch event is one of the touch navigation moving event, the virtual indicator moving event, and an event for selecting a predetermined area and a corresponding icon.

When the navigation performing touch event is determined to be the touch navigation key moving event or the virtual indicator moving event, the touch navigation function performing unit 175 updates position information based on position information of a corresponding event and current position information of the touch navigation key or the virtual indicator. Also, the touch navigation function performing unit 175 controls the display panel 141 so as to display the touch navigation key and the virtual indicator at the updated position on the display panel 141. When the touch navigation key moving event is received, the touch navigation function performing unit 175 may control the display panel 141 to display the touch navigation key at a position designated by the user.

When the virtual indicator moving event is received, the touch navigation function performing unit 175 determines whether the virtual indicator moving event corresponds to an arrow key event or a selection key event. When it is determined that the virtual indicator moving event corresponds to the arrow key event, the touch navigation key performing unit 175 updates the position information of the virtual indicator by determining a moving direction and a moving range of the virtual indicator. The touch navigation function performing unit 175 controls the display panel 141 so as to display the virtual indicator at the updated position.

When it is determined that the virtual indicator moving event corresponds to the selection key event, the touch navigation function performing unit 175 identifies the position information of the virtual indicator and map information of an icon to identify a predetermined area, e.g., an icon at the predetermined area, indicated by the virtual indicator, and supports activation of an application program, operation or function corresponding to the identified icon. Here, the touch navigation function performing unit 175 may perform a function to modify a characteristic of the icon, such as a color or mapping function thereof, according to the application program being executed. Alternatively, when the selection key event is received when the virtual indicator indicates the icon, the touch navigation function performing unit 175 may perform a function associated with the corresponding icon.

In the present exemplary embodiment of the invention, the elements of the controller 170 described above are configured in a case where the detecting of the both hands gripping state is performed by the touch panel 143. Hereinafter, elements of the controller 170, which are configured in a case where the detecting of the both hands gripping state is preformed by the sensor unit 150, are described below. When the sensor unit 150 is set to detect the both hands gripping state according to the sensing information generated by the sensor unit 150, the touch navigation key and virtual indicator output unit 173 may control the display panel 141 to display the touch navigation key based on the sensing information received from the sensing information collection unit 172.

The sensing information collection unit 172 is configured to activate the sensor unit 150 so as to receive the sensing information from the activated sensor unit 150. Particularly, when the sensor unit 150 is set to detect the both hands gripping state according to the sensing information generated by the sensor unit 150, the sensing information collection unit 172 may control a power supply such that the sensor unit 150 is activated in a preset period or according to whether a particular application program is being executed. Also, the sensing information collection unit 172 receives the sensing information from the sensor unit 150. Also, when it is determined that the sensing information is received from proximity sensors disposed at at least two side surfaces of the sensor unit 150, the sensing information collection unit 172 detects an approach and a distance approached by the object based on the collected sensing information. Next, when it is determined that the object contacts two side surfaces of the rear surface of the mobile terminal 100, the sensing information collection unit 172 determines that the mobile terminal 100 is gripped by two hands, and transmits the collected sensing information to the touch navigation key and virtual indicator output unit 173.

The touch navigation key and virtual indicator output unit 173, which receives the sensing information from the sensor unit 150, analyzes the sensing information in order to estimate areas of gripped areas on the rear surface of the mobile terminal 100. Furthermore, the touch navigation key and virtual indicator output unit 173 controls the display panel 141 so as to display the touch navigation key at at least one area of the display panel 141 which faces opposite to the estimated areas. Meanwhile, when the sensor unit 150 includes the proximity sensors arranged in an array structure, the touch navigation key and virtual indicator output unit 173 controls the display panel 141 so as to display the touch navigation key in an area of the display panel 141 that corresponds to an area in which the sensor, which detects the gripping area, is located.

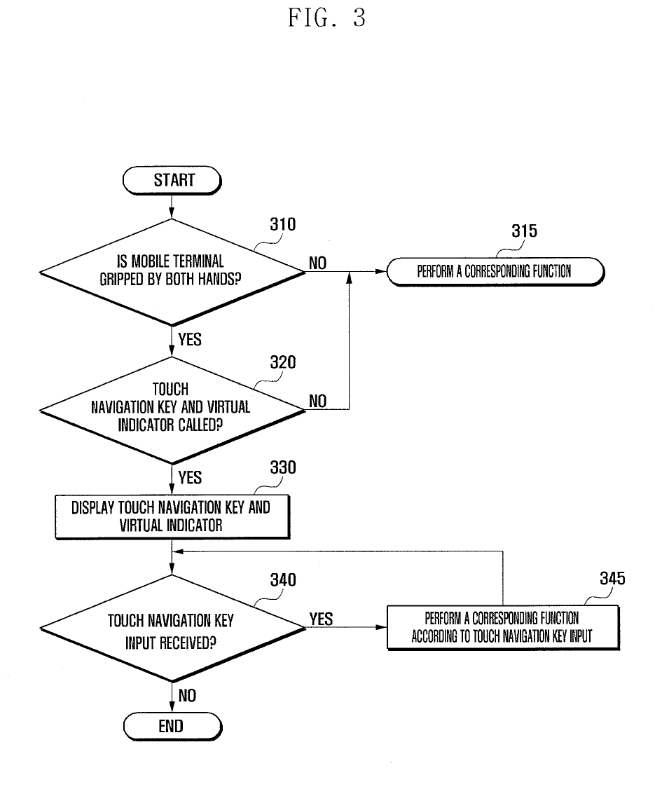

The touch navigation function performing unit 175 performs the touch navigation function according to the user's manipulation of the displayed touch navigation key. An operation of various user functions related to the touch navigation function performing unit 175 will be described in more detail with reference to FIGS. 3 through 5D.

As described above, the mobile terminal 100, according to an exemplary embodiment of the present invention, detects when the mobile terminal 100 is gripped by both hands of the user and outputs the touch navigation key in an area most adjacent to the gripping area of both hands of the user so that the user can easily indicate and select the icon placed at various locations. A procedure of operating of the touch navigation function will be described with reference to FIGS. 3 to 5D.

FIG. 3 is a flowchart diagram illustrating a process of operating a touch navigation function according an exemplary embodiment of the present invention. FIGS. 4A and 4B illustrate a mobile terminal gripped by both hands of a user according to an exemplary embodiment of the present invention. FIGS. 5A through 5D are example screens displayed when a touch navigation key and a virtual indicator are output according to an exemplary embodiment of the present invention.

Referring to FIG. 3, in an exemplary method of operating the touch navigation function, the controller 170 first detects the both hands gripping state of the mobile terminal 100 in step 310. Here, the controller 170 determines whether at least two side surfaces of the mobile terminal 100 are gripped. In such a case, the controller 170 may determine the both hands gripping state based on the sensing information received from the sensor unit 150 or the touch event received from the touch panel 143.

Referring to FIGS. 4A and 4B, the controller 170 may determine the both hands gripping state by using the sensing information received from the sensor unit 150 located on a respective edge portion on the rear surface of the mobile terminal 100. As shown in FIG. 4A, the mobile terminal 100 may include a first proximity sensor R1 that is located, relative to a center of the rear surface of the mobile terminal 100, at a left side of the mobile terminal 100, a second proximity sensor R2 located at a right side of the mobile terminal 100, a third proximity sensor R3 located at an upper side of the mobile terminal 100, and a fourth proximity sensor R4 located at a lower side of the mobile terminal 100.

The controller 170 may determine whether the mobile terminal 100 is gripped at a particular area on a side surface of the display panel 141 by using the sensing information received from the proximity sensor positioned on the same side surface. Also, the controller 170 may control the displaying of the touch navigation key on the display panel 141 so as to be positioned close to an area in which at least one proximity sensor detecting the gripping state is located. Accordingly, the controller 170 may determine a particular area of the display panel 141 that is closer to the gripping area. In the above description, the proximity sensors are described as being respectively positioned at both sides of the display panel 141. However, the present invention is not limited thereto, and the proximity sensors may be positioned in a variety of suitable manners. For example, one proximity sensor may be positioned at a right side surface while multiple proximity sensors are positioned at a regular interval at a left side surface, or vice versa. Alternatively, multiple proximity sensors may be positioned on each side of the rear surface of the mobile terminal 100.

Meanwhile, the control unit 140 may determine the both hands gripping state based on the touch event received from the touch panel 143. Referring to FIG. 4B, the controller 170 may detect the both hands gripping state based on the touch event information received from a gripping detection area 410, which may be a predefined area, and the position information thereof. Particularly, the controller 170 may divide the mobile terminal 100 into at least two areas according to the view mode of the mobile terminal 100 and may identify only the sensing information or the touch event generated therein. As shown in FIGS. 4A and 4B, the gripping detection area 410 is an edge area of the display panel 141 in which icons are not displayed. Additionally, the both hands gripping state notification touch event may be a multi touch generated on respective side surfaces that face opposite to each other, as shown in FIG. 4B, wherein both thumbs of a user are disposed in the gripping detection area 410.

Also, the both hands gripping state notification touch event may be any type of touch event generated in two different side surfaces of the gripping detection area. Accordingly, the controller 170 may determine that the mobile terminal 100 is in the both hands gripping state when the both hands gripping state notification touch event is generated in the gripping detection area based on the received touch event and the position information thereof. Also, instead of using the gripping detection area, the controller 170 may determine that the mobile terminal 100 is in the both hands gripping state based on a distance between locations of touch events (hereinafter, referred to as “touch event distance”) when it is determined that at least two touch events are generated. For example, when the user grips the mobile terminal 100 as shown in FIG. 4B, the controller 170 identifies locations of the touch events and determines the touch event distance so that the both hands gripping state is determined to occur when the touch event distance is equal to or greater than a predetermined distance.

As described above, the controller 170 may determine the both hands gripping state of the mobile terminal 100 in step 310, as shown in FIG. 3. Next, the controller 170 may perform step 320 in the both hands gripping state. When the controller 170 determines that the mobile terminal 100 is in the both hands gripping state in step 310, an entry into the touch navigation mode can be selectively notified through the audio processing unit 130 or the display panel 141. Meanwhile, when it is determined that the mobile terminal 100 is not in the both hands gripping state, the controller 170 performs a corresponding function according to the received sensing information or touch event in step 315.

When the controller 170 determines that the mobile terminal 100 is in the both hands gripping state, the controller 170 determines whether the virtual indicator for indicating a predetermined area of the display panel 141 and at least one touch navigation key, which generates an event related to the control of the virtual indicator, are called, or activated, in step 320. Here, when it is determined that the call touch event occurs within the call area, which is an area that is predefined to call the touch navigation key and the virtual indicator, based on the received touch event and the position information, then the controller 170 performs step 330 so as to control a displaying of the touch navigation key and the virtual indicator. Meanwhile, when it is determined that the touch navigation key and the virtual indicator is not called, i.e., the touch event is generated outside the call area or the touch event predefined to call the touch navigation key and the virtual indicator within the call area does not occur, then the controller 170 performs a corresponding function of the received touch event in step 315.

The controller 170 controls the display panel 141 to display the touch navigation key and the virtual indicator in step 330. The touch navigation key may be displayed in an area of the display panel 141 that is closest to the area in which one of the user's hands, which grip the mobile terminal 100, is located. Particularly, the touch navigation key is preferably displayed within a moving range of a particular finger used to touch the touch screen 140 while the user grips the mobile terminal 100 with both hands. To this end, the controller 170 may refer to the initial output position information that is predefined to be proximate to the gripping area and perform an output control according to the initial output position information such that the display panel 141 displays the touch navigation key at a particular location corresponding to the initial output position information.

Also, the controller 170 may control the display panel 141 so as to output the touch navigation key at a position at which the call touch event is generated. Meanwhile, the virtual indicator is preferably displayed at a location suitable for indicating or pointing to the icon positioned in an area outside a touch operation range of the user gripping the mobile terminal 100 with both hands. In other words, the virtual indicator may be displayed at a location of the display panel 141 that allows for the virtual indicator to indicate or point to an icon that can not be touched when the user is gripping the mobile terminal 100 with both hands of the user. To this end, the controller 170 may refer to the predefined initial output position information of the virtual indicator and control the displaying of the virtual indicator according to the initial output position information such that the virtual indicator is displayed at a particular location of the display panel 141.

Thus, when the touch navigation key and the virtual indicator are displayed, the controller 170 proceeds to step 340. The controller 170 determines whether an input from the touch navigation key, i.e., the navigation performing touch event, is received in step 340. When it is determined that the navigation performing touch event is received, the controller 170 proceeds to step 345 so as to perform a corresponding function according to the touch navigation key input, i.e., perform a touch navigation function. The touch navigation function may include moving the touch navigation key, moving the virtual indicator according to the user's manipulation of the virtual indicator, and activating a particular area, e.g., a particular icon, indicated by the virtual indicator.

The controller 170 refers to the position information of the touch navigation key in order to determine whether the navigation performing touch event corresponds to the arrow key event or the selection key event. When the identified event is the arrow key event, the controller 170 controls the display panel 141 to display the touch navigation key or the virtual indicator at a location, wherein the touch navigation key or the virtual indicator is moved according to a predetermined moving range in a corresponding direction of the arrow key event. Also, when the identified event is the selection key event, the controller 170 activates a particular area, e.g., an icon that is displayed at the particular location, currently indicated by the virtual indicator. Here, the controller 170 may perform the function to modify a characteristic of the icon such as the color or mapping function thereof according to the application program being executed. Alternatively, if the selection key event is received when the virtual indicator indicates the icon, the controller 170 may perform a function corresponding to the icon.

Meanwhile, when it is determined that an input from the touch navigation key is not received, the controller 170 terminates an operation process of the touch navigation function. Additionally, when the controller 170 determines that a touch navigation key input is not received, a process of removing the touch navigation key and the virtual indicator from the display panel 141 may be further performed, and next, the operation process may be terminated. Specifically, when an icon is selected so as to execute a corresponding function of the icon, or a power of the touch screen 140 is turned off, or the touch navigation key input is not received during a predetermined time, the controller 170 may perform a process so as to remove the touch navigation key and the virtual indicator, i.e., to stop displaying the touch navigation key and the virtual indicator on the display panel 141, as described above.

Various application examples of the touch navigation function will be described with reference to FIGS. 5A through 5D. The example screens shown in FIGS. 5A through 5D are output when it is determined that the mobile terminal 100 is in the both hands gripping state.

Referring to FIG. 5A, an exemplary standby screen in which a touch navigation key 520 and a virtual indicator 530 are displayed is illustrated. A call area 510 having a predetermined width is positioned on left and right sides of the display panel 141. Also, when the predefined call touch event occurs in the call area 510, the touch navigation key 520 and the virtual indicator 530 are displayed on the display panel 141. Here, the call touch event may be generated in at least one of a left side or a right side of the call area 510. Here, when the touch navigation mode is entered, i.e., the mobile terminal 100 is determined to be in the both hands gripping state, the call area 510 may be at a particular location of the display panel 141. The user may recognize an area for displaying the touch navigation key and the virtual indicator by identifying the call area 510.

The touch navigation key 520 may be implemented as a combination of the arrow key and the selection key, as described above with respect to FIGS. 4A and 4B. The touch navigation key 520 is displayed in an area of the display panel 141 which is the closest area to the area at which the mobile terminal 100 is gripped. Here, the touch navigation key 520 may be displayed according to the initial output position information or the position information of the call touch event.

The virtual indicator 530 may be implemented as a boundary highlight of an icon, or in other words, the virtual indicator 530 may be an outline or shadow placed around an icon. However, the present invention is not limited thereto, and the virtual indicator 530 may be implemented in a variety of suitable manners. The virtual indicator 530 may be displayed so as to indicate the icon closest to a predetermined area, e.g., the center area, of the touch screen 140. Accordingly, when the arrow key of the touch navigation key 520 is selected by a user's finger that does not grip the mobile terminal 100, the virtual indicator 530 may be moved to indicate a next icon located along a selected direction. Also, when the selection key is touched, the icon indicated by the virtual indicator 530 is activated so as to perform the function corresponding to the icon.

FIG. 5B illustrates another exemplary standby screen in which a touch navigation key and a virtual indicator are displayed according to an exemplary embodiment of the present invention.

Referring to FIG. 5B, the touch navigation key 520 is implemented as a touch pad map that has a rectangular shape. Also, the virtual indicator 530 is implemented as a pointer so as to indicate an icon located farthest away from a point at which the touch navigation key 520 is displayed. The user may perform a touch operation in the touch pad map in order to move the virtual indicator 530 in a desired direction, such as a forward direction, a backward direction, a left direction, a right direction, a diagonal direction, or any other similar direction.

As shown in FIGS. 5A and 5B, the user may manipulate the touch navigation key 520 with a touch operation occurring in a relatively small area, with one hand, thereby being able to easily select an icon located in a particular position not accessible by a user's touch when the mobile terminal 100 is in a both hands gripping state.

FIG. 5C illustrates an exemplary screen of a music playback application in which a touch navigation key and a virtual indicator are displayed according to an exemplary embodiment of the present invention.

According to the present exemplary embodiment, the touch navigation key is displayed as the arrow key 520A and the selection key 520B, which are respectively located in two areas on the display panel 141 that are closest to the area at which the mobile terminal 100 is gripped. Also, the virtual indicator 530 is implemented as a pointer. For example, in a case where the arrow key 520A is displayed on a left side of the display panel 141, the selection key 520B may be displayed on a right side of the display panel 141. Here, the arrow key 520A may be displayed in an area close to an area at which the mobile terminal 100 is gripped by a user's left hand, and the selection key 520B may be displayed in an area close to an area at which the mobile terminal is gripped by the user's right hand. The user may move the left hand to control the arrow key 520B in order to manipulate a direction of the virtual indicator 530 and may move the right hand to control the selection key 520B so as to select a predetermined area of the display panel or activate a particular application corresponding to a selected icon.

FIG. 5D shows an exemplary E-book screen in which the touch navigation key and the virtual indicator are displayed according to an exemplary embodiment of the present invention.

Referring to FIG. 5D, the touch navigation key is displayed as the arrow keys respectively located in two areas of the display screen 141. A first touch navigation key 521 is located at a left side of the display screen 141. The first touch navigation key 521 may have a greater moving range width for moving the virtual indicator 530 than a moving range width of a second touch navigation key 522. However, the present invention is not limited thereto, and any suitable setting of respective moving range widths may be implemented. For example, when the first touch navigation key 521 is selected, a page of an e-book may be turned over in a manner corresponding to a first moving range of the first touch navigation key 521. Additionally, when the second touch navigation key 522 is selected, multiple pages, e.g., 10 pages, corresponding to a second moving range that is different from the first moving range, may be turned over.

In the present exemplary embodiment, the virtual indicator 530 may be displayed in a manner corresponding to a page of the e-book, for example, as an outline surrounding a displayed page of the e-book, as illustrated in FIG. 5D. However, the present invention is not limited thereto, and the virtual indicator 530 may be implemented in a variety of suitable manners. Furthermore, the first touch navigation key 521 and the second touch navigation key 522 may be respectively set so as to have different moving ranges of the virtual indicator 530. Based on this, the moving range of the virtual indicator 530 may be controlled so that the user can conveniently and quickly turn over a page of the electronic book when the mobile device 100 is in the both hands gripping state. Here, the moving range is described in terms of pages of the e-book, however, the present invention is not limited thereto, and the moving range may be a moving distance by which the virtual indicator in the pointer form is moved on the display panel, or any other suitable range corresponding to a moving distance of the virtual indicator.

As described above, according to the exemplary embodiments of the present invention, a method of operating the touch navigation function and a mobile terminal for supporting the same are provided for when the mobile terminal is determined to be in the both hands gripping state, and thus, a particular location on the touch screen may be easily selected or a particular icon may be easily indicated or selected by a touch operation of a user that occurs near an area at which the mobile terminal is gripped by both hands of the user.

As described above, according to a method of operating a touch navigation function and a mobile terminal for supporting the same according to exemplary embodiments of the present invention, various areas of a touch screen may be easily selected or an application, operation or function corresponding to an icon disposed on the touch screen may be easily and effectively activated through a touch operation that occurs within a limited area.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method of operating a touch navigation function, the method comprising:
detecting a both hands gripping state of a mobile terminal if both hands of a user are gripping the mobile terminal;
determining whether a virtual indicator for indicating a particular area of a display panel of the mobile terminal is called;
determining whether at least one touch navigation key configured to generate an event related to a control of a movement of the virtual indicator is called;
displaying the at least one virtual indicator in the predetermined area of the display panel if it is determined that the virtual indicator is called;
displaying the touch navigation key in at least one area of the display panel that is adjacent to an area in which both hands gripping the mobile terminal are located if it is determined that the at least one navigation key is called; and
performing, based on a predefined touch event generated according to a control of the touch navigation key, at least one of, a function to indicate the predetermined area of the display panel, a function to move the virtual indicator outputted on the predetermined area of the display panel, and a function to activate the predetermined area of the display panel indicated by the virtual indicator.

2. The method according to claim 1, wherein the detecting of the both hands gripping state comprises:
determining at least one of whether a touch event generated in a predefined gripping detection area of a touch panel disposed on the display panel corresponds to a predefined touch event and whether a plurality of touch events generated on the touch panel are separated apart from each other by a distance equal to or greater than a predetermined distance; and
detecting of the both hands gripping state according to the generation of the touch event in the predefined touching area or the plurality of the touch events generated on the touch panel are separated apart from each other by the distance equal to or greater than the predetermined distance.

3. The method according to claim 2, wherein the displaying of the touch navigation key comprises:
determining whether a location at which the predefined touch event is generated is in a predefined call area of the touch panel; and
outputting the touch navigation key in an area adjacent to the location at which the predefined touch event is generated.

4. The method according to claim 3, wherein at least one of the gripping detection area and the call area has a predetermined width and is disposed at at least two side surfaces of the touch panel.

5. The method according to claim 4, wherein the two side surfaces are respectively disposed at opposite sides of the touch panel.

6. The method according to claim 1, wherein the detecting of the both hands gripping state comprises:
detecting sensing information from a sensor unit disposed at an edge area of a rear surface of the mobile terminal; and
determining whether the sensing information is sensing information corresponding to the both hands gripping state.

7. The method according to claim 6, wherein the displaying of the touch navigation key comprises:
determining a location of at least one proximity sensor that generates the sensing information; and
displaying the touch navigation key in an area of the display panel that is adjacent to an area in which the at least one proximity sensor is disposed.

8. The method according to claim 1, wherein the displaying of the touch navigation key comprises at least one of:
displaying an arrow key or a touch pad map for moving the virtual indicator in an area of the display panel that is adjacent to an area gripped by the both hands;
simultaneously displaying the arrow key for moving the virtual indicator and a selection key for selecting the particular area indicated by the virtual indicator in the area of the display panel that is adjacent to the area gripped by the both hands;
displaying the arrow key for moving the virtual indicator in a first area of the display panel that is adjacent to the area gripped by the both hands and the selection key for selecting the particular area indicated by the virtual indicator in a second area of the display panel that is adjacent to the area gripped by the both hands; and
displaying a first arrow key for moving the virtual indicator according to a first moving range in the first area of the display panel that is adjacent to the area gripped by the both hands and displaying a second arrow key for moving the virtual indicator by a second moving range that is different from the first moving range in a second area of the display panel that is adjacent to the area gripped by the both hands.

9. The method according to claim 1, further comprising removing the touch navigation key and the virtual indicator when the predefined touch event is generated.

10. The method according to claim 1, wherein either of the virtual indicator and the at least one touch navigation key are determined to be called according to a determination as to whether a touch event is detected in a call area of the display panel.

11. The method according to claim 1, wherein the call area is an area adjacent to the area in which both hands gripping the mobile terminal are located.

12. A mobile terminal supporting a touch navigation function, the mobile terminal comprising:
a display panel for displaying a virtual indicator for indicating a particular area and at least one touch navigation key for generating an event related to movement of the virtual indicator and for controlling the movement of the virtual indicator;
a touch panel for generating a touch event according to a user input and for generating a predefined touch event according to a both hands gripping state, and a sensor unit configured to generate sensing information according to the both hands gripping state; and
a controller for controlling a displaying of the touch navigation key in an area of the display panel that is adjacent to an area in which both hands of a user gripping the mobile terminal are located when the both hands gripping state is detected.

13. The mobile terminal according to claim 12, wherein the controller is for supporting, according to a touch event generated according to a control of the touch navigation key, at least one of a function for indicating the particular area of the display panel, a function for moving the virtual indicator displayed at the particular area of the display panel, and a function for activating a function corresponding to the predetermined area of the display panel indicated by the virtual indicator.

14. The mobile terminal according to claim 12, wherein the touch panel comprises:
a gripping detection area set to detect the predefined touch event for detecting the both hands gripping state; and
a call area for displaying the touch navigation key and the virtual indicator.

15. The mobile terminal according to claim 14, wherein the call area is an area adjacent to the area in which both hands gripping the mobile terminal are located.

16. The mobile terminal according to claim 15, wherein at least one of the gripping detection area and the call area has a predetermined width and is formed at at least two side surfaces of the touch panel,
wherein the two side surfaces are opposite to each other with respect to the touch panel.

17. The mobile terminal according to claim 12, wherein the sensor unit comprises a plurality of proximity sensors positioned at an edge area of a rear side of the mobile terminal.

18. The mobile terminal according to claim 17, wherein the controller is for controlling a displaying of the touch navigation key on the display panel at an area adjacent to an area in which at least one proximity sensor that generates the sensing information from among the plurality of the proximity sensors is located.

19. The mobile terminal according to claim 12, wherein the display panel displays at least one of:
the touch navigation key including an arrow key or a touch pad map for moving the virtual indicator, the touch pad map being displayed in an area of the display panel that is adjacent to an area gripped by both hands;
the touch navigation key including the arrow key for moving the virtual indicator and a selection key for selecting the particular area indicated by the virtual indicator, the touch pad map being displayed in the area of the display panel that is adjacent to the area gripped by both hands;
the touch navigation key including the arrow key for moving the virtual indicator, the arrow key being displayed in a first area of the display panel that is adjacent to the area gripped by both hands, and the selection key for selecting the particular area indicated by the virtual indicator, the selection key being displayed simultaneously with the arrow key in a second area of the display panel that is adjacent to the area gripped by both hands; and
the touch navigation key including a first arrow key for moving the virtual indicator according to a first moving range in the first area of the display panel that is adjacent to the area gripped by the both hands and a second arrow key for moving the virtual indicator by a second moving range that is different from the first moving range in a second area of the display panel that is adjacent to the area gripped by the both hands

20. The mobile terminal according to claim 12, wherein the controller is for removing the touch navigation key and the virtual indicator when a predefined touch event is generated.
